(19) United States
(12) Patent Application Publication
(10) Pub. No.: US 2023/0334301 A1
(43) Pub. Date: Oct. 19, 2023

(54) METHOD, COMPUTER PROGRAM AND DEVICE FOR QUANTIZING A DEEP NEURAL NETWORK

(71) Applicants: BULL SAS, Les Clayes-sous-Bois (FR); INSTITUT NATIONAL POLYTECHNIQUE DE TOULOUSE, TOULOUSE (FR); UNIVERSITE TOULOUSE III - PAUL SABATIER, TOULOUSE (FR); CENTRE NATIONAL DE LA RECHERCHE SCIENTIFIQUE, PARIS (FR)

(72) Inventors: Stéphane PRALET, AUTRANS (FR); Théo BEUZEVILLE, TOULOUSE (FR); Alfredo BUTTARI, TOULOUSE (FR); Serge GRATTON, TOULOUSE (FR)

(73) Assignees: BULL SAS, Les Clayes-sous-Bois (FR); INSTITUT NATIONAL POLYTECHNIQUE DE TOULOUSE, TOULOUSE (FR); UNIVERSITE TOULOUSE III - PAUL SABATIER, TOULOUSE (FR); CENTRE NATIONAL DE LA RECHERCHE SCIENTIFIQUE, PARIS (FR)

(21) Appl. No.: 18/299,907

(22) Filed: Apr. 13, 2023

(30) Foreign Application Priority Data
Apr. 14, 2022 (EP) 22305553.4

(51) Int. Cl. G06N 3/0495

(52) U.S. Cl. CPC G06N 3/0495

(57) ABSTRACT

The invention relates to a method for quantizing a deep neural network including several layers, previously trained during a training phase determining for each layer a set of weights. The method includes a phase of quantizing the deep neural network including determining a disruption limit value of at least one weight of the weight set of the layer, beyond which the output of the deep neural network is erroneous, determining, for a target inference precision of the neural network, and from the disruption limit value, an adjustment limit value of at least one weight of the set of weights, and decreasing an arithmetic precision of at least one weight of the set of weights as a function of the adjustment limit value. The invention also relates to a computer program, a device implementing such a method, and a deep neural network obtained by such a method.

This application claims priority to European Patent Application Number 22305553.4, filed 14 Apr. 2022, the specification of which is hereby incorporated herein by reference.

### BACKGROUND OF THE INVENTION

### Field of the Invention

At least one embodiment of the invention relates to a method for quantizing a deep neural network. At least one embodiment also relates to a computer program and a device implementing such a method, and a deep neural network obtained by such a method.

The field of the invention is generally the field of the quantization of a deep neural network in order to reduce the inference cost of said neural network.

### Description of the Related Art

The development and use of a neural network generally takes place in several phases. A first phase, referred to as the training phase, is intended to train the neural network on a base of training sets; this training phase requires a significant amount of computing power, time, and training data. A second phase, called the use phase or inference phase, makes it possible to apply the trained neural network to a data stream on-the-fly, multiple times. This use phase can take place on apparatuses with limited computing resources, such as Edge infrastructures or IoT devices. Thus, it is important for the trained neural network to have an inference cost, in terms of computing and runtime resources, which is acceptable for these apparatuses.

There are quantization techniques that make it possible to reduce the inference cost of a neural network. One solution consists of reducing the arithmetic precision of the weights of the neural network, for example by passing them from FP32 arithmetic precision (“single precision floating point”), to FP16 arithmetic precision (“half precision floating point”) or FP8 (“minifloat”), or even an arithmetic precision as an integer (INT). This solution can be implemented during the training phase or after the training phase.

This solution makes it possible to reduce the inference cost of the neural network but has the drawback of drastically reducing its inference performance, or its robustness, sometimes making it unusable.

One aim of at least one embodiment of the invention is to solve at least one of the drawbacks of the state of the art.

Another aim of at least one embodiment of the invention is to propose a solution for optimizing the inference cost of a deep neural network, while limiting the reduction in the inference performance of said deep neural network.

### BRIEF SUMMARY OF THE INVENTION

At least one embodiment of the invention proposes to achieve at least one of the aforementioned aims by a method of quantization of a deep neural network, DNN, previously trained during a training phase determining for each layer of said deep neural network a set of weights, said method comprising a phase of quantization of said deep neural network comprising the following steps:
determining, for at least one layer of said trained deep neural network, a disruption limit value of at least one weight of the set of weights of said layer, beyond which the output of said deep neural network is erroneous,
determining, for a target inference precision and from said disruption limit value, an adjustment limit value of at least one weight of said set of weights, and
decreasing an arithmetic precision of at least one weight of said set of weights as a function of said adjustment limit value.

Thus, one or more embodiments of the invention proposes to reduce the arithmetic precision of at least one, and in particular, of several weights, of at least one layer, and in particular of each layer, of the deep neural network, DNN. Thus, in at least one embodiment, the inference cost of the DNN is reduced. Indeed, the arithmetic precision of at least one weight of the neural network being reduced, its execution on an apparatus requires fewer computing resources, less computing time, and less energy.

At least one embodiment of the invention proposes carrying out a quantization of the DNN, after said DNN has been trained, contrary to certain techniques of the prior art that perform a quantization during the training phase. Compared to these techniques, the solution proposed by at least one embodiment of the invention makes it possible not to disrupt the DNN training phase.

Furthermore, unlike certain techniques of the state of the art which perform a uniform quantization on all the weights of the DNN, one or more embodiments of the invention proposes carrying out a quantization of the DNN individually for at least one weight of the DNN, as a function of a disruption limit value and a target inference precision after quantization. Compared to these techniques, the solution proposed by at least one embodiment of the invention makes it possible to carry out a quantization of the DNN with less impact, or even with no impact, on the inference precision of said DNN.

In at least one embodiment, “quantization” of an DNN means decreasing the inference cost of said DNN by reducing the arithmetic precision of all or some of the weights of said DNN.

The disruption limit value of a weight, or a set of weights, corresponds to a change limit, of said weight, or of said set of weights, beyond which an error on the DNN output is obtained.

The DNN comprises I layers, with I≥2.

A set of weights associated with a layer of the DNN comprises one or more weights associated with a neuron, the number of weights depending on the number of inputs of said neuron. In the following, and without loss of generality, the set of weights of the layer “i” of the DNN may be denoted, Aᵢ. The sets of weights of two layers of the DNN may comprise the same number of weights, or different numbers of weights. In the remainder of the description, for sake of simplicity and without loss of generality, it is considered that the set of weights of each layer of the DNN comprises a same number of weights such that

Aᵢ={Aᵢ₁, . . . ,Aᵢₖ, . . . ,A_{iK}}, with k=1, . . . ,K where K≥1.

Hereinafter, the adjustment value can be denoted, without loss of generality, δ. Thus, the adjustment value associated with a layer “i” is denoted δᵢ and the adjustment value associated with the weight “k” of the layer “i” is denoted δᵢₖ.

According to one or more embodiments, the disruption limit value can be calculated for at least one, and in particular for each, weight of at least one set of weights, and in particular each set of weights. In this case, the disruption limit value is valid only for said weight.

According to one or more embodiments, the disruption limit value can be calculated for at least one, and in particular for each, set of weights considered to be a set, and not for each weight of said set of weights individually. In this case, in at least one embodiment, the disruption limit value is valid only for said set of weights so that it is calculated for all the weights of said set of weights. In other words, in at least one embodiment, the disruption limit value indicates the change limit for all the weights of said set of weights, for which the DNN output is not changed. In this case, in one or more embodiments, at least two weights of said set of weights may be adjusted differently. It is also possible, for example, to adjust only a portion of the weights of said set of weights. For example, for the layer “i” of the DNN, the disruption limit value can be denoted ΔAᵢ, such that:

ΔAᵢ={ΔAᵢ₁, . . . ,ΔAᵢₖ, . . . ,ΔA_{iK}}

Thus, one or more weights of the layer i may be modified, an identical value, or different: as long as the set of changes does not exceed ΔAᵢ the DNN output will not be modified.

According to one or more embodiments, for at least one layer, the disruption limit value ΔAᵢ can be calculated for the norm of the vector Aᵢ such that:

ΔAᵢ=∥{ΔAᵢ₁, . . . ,ΔA_{iK}}∥

According to one or more embodiments, the adjustment value can be calculated for at least one, and in particular for each, weight of at least one set of weights, and in particular of each set of weights. In this case, in at least one embodiment, the adjustment limit value is valid only for said weight.

According to one or more embodiments, the adjustment value can be calculated for at least one, and in particular for each, set of weights considered to be a set, and not for each weight individually. In this case, in at least one embodiment, the adjustment value is valid only for said set of weights so that it is calculated for all the weights of said set of weights. In other words, the adjustment value indicates the total change for all weights of said set of weights, for which the DNN output provides the target precision. In this case, in at least one embodiment, at least two weights of said set of weights may be adjusted differently. It is also possible, for example, to adjust only a portion of the weights of said set of weights. For example, without loss of generality, for the layer “i” of the DNN, the adjustment value may be denoted δAᵢ, such that:

δAᵢ={δAᵢ₁, . . . ,δA_{iK}}

Thus, one or more weights of the layer “i” may be modified, by a different or identical value; as long as the set of modifications does not exceed δAᵢ, the inference precision of the DNN will be greater than or equal to the target precision.

According to one or more embodiments, for at least one layer, the adjustment limit value ΔAᵢ can be calculated for the norm of the vector Aᵢ such that:

δAᵢ=∥{δAᵢ₁, . . . ,δAᵢₖ}∥

According to one or more embodiments, the adjustment limit value may be equal to the disruption limit value.

In the case where these values are calculated for a layer “i” of the DNN, then ΔAᵢ=δAᵢ.

In one or more embodiments, the inference precision of the DNN is not affected by the changes made to the weights of the DNN.

According to one or more embodiments, the adjustment limit value may be greater than the disruption limit value.

In this case, in at least one embodiment, the inference precision can be degraded, but this can make it possible to further reduce the inference cost of the DNN with a target precision that remains acceptable.

According to one or more embodiments, the adjustment limit value can be determined by iterative search, by dichotomy, or any other method.

According to at least one embodiment, the step of determining the adjustment limit value may comprise at least one iteration of the following operations:
for at least one, in particular each layer, of the deep neural network, choosing a candidate adjustment value greater than said disruption limit value,
modifying the value of at least one weight of said layer of said candidate adjustment value, and
measuring the inference precision of said deep neural network thus modified on a test base;
   said operations being reiterated until the adjustment limit value is identified for which the measured inference precision corresponds to the target inference precision.

The decreasing step may comprise setting to zero at least one weight whose value is less than the adjustment limit value.

In the case where the adjustment limit value is calculated for a layer “i”, one or several weights of the layer may be set to zero as long as the total value of these weights is less than the adjustment limit value.

Thus, each weights set to zero does not intervene during the iteration phase, which makes it possible to reduce the total inference cost of the DNN accordingly.

Alternatively, or in addition, by way of one or more embodiments, the step of reducing may comprise a change in the arithmetic precision of at least one weight to a less precise arithmetic precision, for example by changing the arithmetic precision of said weight from a first arithmetic precision to a second, less precise arithmetic precision.

Indeed, in at least one embodiment, when the change in arithmetic precision of a weight means that the loss of precision is less than or equal to the adjustment limit value, then the arithmetic precision of the weight can be changed. For example, the arithmetic precision of the weight can be changed from a precision FP32, to an arithmetic precision FP16, FP or even an integer. In this case, in at least one embodiment, the inference cost due to this weight will be reduced, which will reduce the inference cost.

Alternatively, or in addition, by way of one or more embodiments, the quantization phase can comprise setting to zero at least one weight whose value is less than the value of the computing precision, often called “epsilon machine”, of the apparatus on which the DNN is intended to be run.

Such a modification has no consequence on the inference precision that it is possible to have for the DNN on that apparatus.

The value of the machine precision can be entered by a user, or read from a database for the relevant apparatus or type of apparatus.

According to one or more embodiments, for at least one, in particular each, layer, the disruption limit value can be identified by a backward error technique applied to the weights of the deep neural network.

Such a technique for seeking the disruption limit value makes it possible to determine the disruption limit value starting from the error provided in the output of the DNN, in order to determine the limit disruptions of the weights of the DNN.

Indeed, by denoting Y′ and Y the disrupted and undisrupted outputs of the DNN comprising I layers, it is possible to write:

Y′=fᵢ((Aᵢ+ΔAᵢ)f_{I-1}((A_{I-1}+ΔA_{I-1}) . . . (A2+ΔA2)f1((A1+ΔA1)(x+Δx))

where
fᵢ is the activation function of the layer i of the DNN,
Aᵢ is the vector of the weights of the layer i of the DNN, and
ΔAᵢ the disruption limit value such that Y=Y′
   Assuming that the activation functions are differentiable, and taking a first-order approximation, identifying the ΔAᵢ values involves finding the solution to the following problem:

$${min}_{Δ {A}_{i}} {\sum }_{i = 1}^{I} \frac{{‖ Δ {A}_{i} ‖}^{2}}{{‖ {A}_{i} ‖}^{2}}$$

with the condition that Y-Y′=ΔY=AΔAᵢ where:

$${A}^{T} = [ \begin{matrix}x ⊗ {( {f}_{p}^{′} ( {A}_{p} {y}_{p - 1} ) {A}_{p} … {f}_{1}^{′} ( {A}_{1} x ) )}^{T} \\ ⋮ \\ {y}_{i - 1} ⊗ {( {f}_{p}^{′} ( {A}_{p} {y}_{p - 1} ) {A}_{p} … {f}_{i}^{′} ( {A}_{i} {y}_{i - 1} ) )}^{T} \\ ⋮ \\ {y}_{p - 1} ⊗ {( {f}_{p}^{′} ( {A}_{p} {y}_{p - 1} ) )}^{T} {( {f}_{p}^{′} ( {A}_{p} {y}_{p - 1} ) {A}_{p} … {f}_{1}^{′} ( {A}_{1} x ) {A}_{1} )}^{T}\end{matrix} ]$$

Thus, the ΔAᵢ will correspond to the disruption values of the weights of the layer i beyond which the approximate output Y′ of the DNN will be sufficiently different from the output Y so that the inference precision will be impacted.

According to one or more embodiments, for at least one, in particular each, layer, the disruption limit value can be identified by a BERR statistical technique.

For example, the forward error

$$\frac{‖ Δ Y ‖}{‖ Y ‖}$$

is related by the condition number κ to the backward error

$$\frac{‖ Δ {A}_{i} ‖}{‖ {A}_{i} ‖}$$

by the following formula:

$$\frac{‖ Δ Y ‖}{‖ Y ‖} ⩽ κ ( {A}_{i} ) \frac{‖ Δ {A}_{i} ‖}{‖ {A}_{i} ‖} .$$

For example, for a neural network used for regression, an error at the output of the network

$$( \frac{‖ Δ Y ‖}{‖ Y ‖} )$$

deemed acceptable is provided, for example, by the user.

Knowing the condition number of the neural network from the formulas obtained by the backward error analysis approach, the disruption limit value compatible with the output error level is then obtained.

According to one or more embodiments, the deep neural network may be a deep neural network trained for:
a classification of objects in at least two classes; or
a regression of an item of input data in order to provide an item of output data.

Such deep neural networks are well known and it is not necessary to describe them in more detail here.

Such neural networks can be used for image analysis, for detecting objects in the images, for tracking a target object in the images, for calculating a signature of an image, but also for other types of applications such as predicting a trajectory, etc.

According to at least one embodiment of the invention, a computer program is proposed comprising executable instructions which, when they are executed by a computer apparatus, implement all the steps of the method according to one or more embodiments of the invention, for quantizing a deep neural network.

The computer program can be in any computer language, such as, for example, in machine language, in C, C++, JAVA, Python, etc.

According to at least one embodiment of the invention, a device is proposed for quantizing a deep neural network comprising means configured to implement all the steps of the method, according to one or more embodiments of the invention, for quantizing a deep neural network.

The device according to at least one embodiment of the invention may be any type of apparatus such as a server, a computer, a tablet, a calculator, a processor, a computer chip, programmed to implement the method according to one or more embodiments of the invention, for example by the computer program according to at least one embodiment of the invention.

The device can be a physical machine or a virtual machine.

The device may comprise any combination of hardware means and/or software means.

According to at least one embodiment of the invention, a deep neural network obtained by the method according to one or more embodiments of the invention for quantizing a deep neural network is proposed.

Such a deep neural network may be a neural network trained for classification or for regression.

Such a deep neural network can be trained to, and used for, any type of application, such as image analysis, object tracking, voice recognition, etc. in any technical field such as industry, medicine, etc.

### BRIEF DESCRIPTION OF THE DRAWINGS

Other benefits and features shall become evident upon examining the detailed description of entirely non-limiting examples of one or more embodiments, and from the appended drawings in which:

FIGS. 1a and 1b are schematic depictions of a deep neural network according to one or more embodiments of the invention;

FIG. 2 is a schematic depiction of a method according to one or more embodiments of the invention;

FIG. 3 is a schematic depiction of another method according to one or more embodiments of the invention; and

FIG. 4 is a schematic representation of a device according to one or more embodiments of the invention.

### DETAILED DESCRIPTION OF THE INVENTION

It is clearly understood that the one or more embodiments that will be described hereafter are by no means limiting. In particular, it is possible to imagine variants of the one or more embodiments of the invention that comprise only a selection of the features disclosed hereinafter in isolation from the other features disclosed, if this selection of features is sufficient to confer a technical benefit or to differentiate the one or more embodiments of the invention with respect to the prior art. This selection comprises at least one preferably functional feature which is free of structural details, or only has a portion of the structural details if this portion alone is sufficient to confer a technical benefit or to differentiate the one or more embodiments of the invention with respect to the prior art.

In particular, all of the described variants and embodiments can be combined with each other if there is no technical obstacle to this combination.

In the figures and in the remainder of the description, the same reference has been used for the features that are common to several figures.

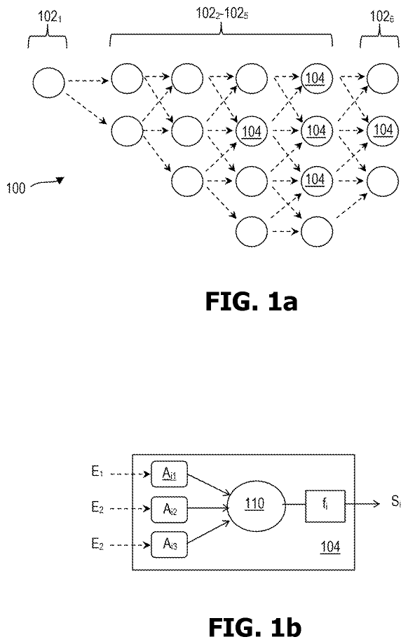

FIGS. 1a and 1b are schematic depictions of a deep neural network according to one or more embodiments of the invention.

The network of neurons, or neural network 100, shown in FIG. 1a, comprises 6 layers 102₁-102₆. Each layer 102ᵢ comprises one or more neurons 104. Each neuron 104 of a layer 102ᵢ receives as input one or more signals from one or several neurons of the previous layer, except for the first layer 102ᵢ, and provides one or more outputs to the input of one or several neurons of a subsequent layer, except for the last layer 102₆.

In the neural network 100, the layer 102₁ is an input layer that can comprise one or more neurons. In the example shown, by way of at least one embodiment, the input layer 102₁ comprises a single neuron. This layer 102ᵢ receives the data entered in the neural network 100.

The layer 102₆ is a decoding layer 106, also called the output layer. In the example shown, by way of at least one embodiment, the output layer 102₆ comprises, in a non-limiting manner, three neurons. The last layer 102₆ provides the output data of the neural network 100.

The neural network 100 further comprises several encoding layers, also called hidden layers, between the input layer 102₁ and the output layer 102₆. In the example shown, by way of at least one embodiment, the neural network 100 comprises four hidden layers 102₂-102₅. Each hidden layer 102₂-102₅ may comprise a same number, or a different number, of neurons. In the example shown, by way of at least one embodiment, each hidden layer 102₂-102₅ comprises 2, 3, or 4 neurons in the direction from the input layer 102₁ to the output layer 102₆ of the neural network 100.

Of course, this example is provided for purposes of illustration only and is in no way limiting.

In the represented neural network 100, a neuron of a layer is connected to a neuron of the following layer, except for the output layer 102₆. In other words, by way of at least one embodiment, a neuron of a layer receives the output from one or more neurons of a previous layer, except for the input layer 102₁. In FIGS. 1a and 1b, all the possible routes between the neurons 104 are represented with dotted arrows.

FIG. 1b is a schematic, non-limiting presentation of a neuron 104, according to one or more embodiments of the invention.

As shown, the neuron 104 can receive as input, potentially the output of several neurons from a previous layer, in particular three neurons in the example shown.

The output of each neuron of a previous layer received at the input of the neurons 104, that is to say each item of data E₁-E₃, received at the input of the neuron 104, is weighted by a weight. In the example shown, each of the three items of data E₁-E₃ received at the input of the neuron 104 is weighted by a weight, respectively Aᵢ₁-Aᵢ₃. The weighted data are then aggregated by an aggregation function and then entered into an activation function, denoted fᵢ. Depending on the result returned by the activation function fᵢ, the neuron 104 is activated or not. If the neuron 104 is activated, it provides an item of data Sᵢ at the output and the output Sᵢ of the neuron 104 is then provided at the input of one or more neurons of the next layer of the neural network 100.

It is understood that the inference cost of the neural network 110 depends on the one hand on the number of weights Aᵢ₁-Aᵢ₃ and on the other hand on the arithmetic precision with which each of the weights Aᵢ₁-Aᵢ₃is represented.

One or more embodiments of the invention makes it possible to perform a quantization of the neural network 100 in order to reduce the inference cost of said neural network 100, that is to say the calculation time during an inference, the computing resources necessary for the inference of the neural network 100, or even the energy consumed by the neural network 100 during an inference, and this, while limiting or avoiding a loss of the inference precision.

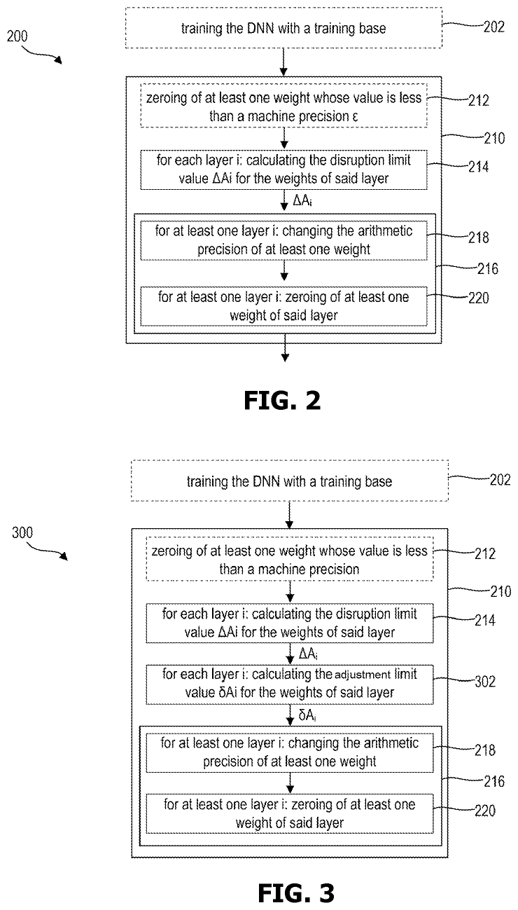

FIG. 2 is a schematic depiction of a method for quantizing a deep neural network, DNN, according to one or more embodiments of the invention.

The method 200 of FIG. 2 can be used to carry out the quantization of any type of DNN, and in particular of DNN 100 of FIG. 1, by way of at least one embodiment of the invention.

The DNN is trained during a training phase 202 with a training base (not shown). This training phase 202 may or may not be part of the method according to one or more embodiments of the invention. In the example shown, the training phase 202 is not part of the method 200.

The trained DNN is quantized during a quantization phase 210 of the method 200 according to one or more embodiments of the invention. This quantization phase 210 aims to reduce the inference cost of the trained DNN, by decreasing:
the computing resources consumed for an inference of the DNN,
the calculation time for an inference of the DNN, and/or
the electrical energy consumed for an inference of the DNN.

To do this, the quantization phase 210 may optionally comprise a step 212 of adjusting at least one weight of the neural network as a function of the machine precision, denoted E, of the apparatus (or of the type of apparatus) on which said neural network will be used, such as a camera, a computer, a tablet, a smartphone, etc.

To do this, step 212 takes into account the machine precision ε corresponding to the calculation precision used by the apparatus, or the type of apparatus. This precision ε can be provided as input data to the method 200, or may be read from a database. Then, in step 212 all weights Aᵢₖ of the trained deep neural network whose value is lower than the machine precision ε are set to zero. Indeed, by way of at least one embodiment, since these weights have a value less than the machine precision, considering them has no impact during the inference of the deep neural network on the apparatus, or type of apparatus, running the neural network during the inference phase.

During a step 214, a disruption limit value of the weights of the neural network, leading to a change in the output of the neural network, is calculated. For example, by way of at least one embodiment, for a neural network used for classification, the disruption limit value may correspond to the smallest disruption value of the weights of said neural network leading to a change of class, while complying with a precision criterion set by the user. Regarding a neural network used for regression, the disruption limit value corresponds to the smallest disruption value of the weights of said neural network that leads, at most, to a change in the value provided for each data item at the input of the neural network.

According to at least one embodiment, the disruption limit value can be calculated for each layer of the neural network, that is to say for all the weights of a layer of said neural network. For example, Aᵢ is the vector comprising all the weights Aᵢ₁-Aᵢₖ of the layer i, such that

Aᵢ={Aᵢ₁, . . . ,Aᵢₖ, . . . ,A_{iK}}, where K≥1.

and ΔAᵢ is the total disruption limit value for all weights of the layer i such that:

$$Δ {A}_{i} = {\sum }_{k = 1}^{k = K} Δ {A}_{ik}$$

In this case, by way of at least one embodiment, the disruption limit value ΔAᵢ corresponds to a total limit value for the sum of all the disruptions for the set of weights of the i-th layer of the neural network. Thus, step 214 provides for each layer i a disruption limit value ΔAᵢ. If the total disruption applied to the weights of the layer i is less than ΔAᵢ then the output of the trained deep neural network is not disrupted, so that the inference precision of the trained deep neural network is not impacted by said disruption. Otherwise, the inference precision of the trained DNN is impacted.

Of course, according to one or more embodiments, the disruption limit value may be calculated for each weight individually or for all the weights of the neural network.

During a step 216, for each layer i, the arithmetic precision of the weights of said layer is decreased while ensuring that this decrease in precision provides a total modification of the values of the weights of said layer i below the limit ΔAᵢ calculated for said layer i. In other words, by way of at least one embodiment, during step 216, the modification Δ′Aᵢ of the arithmetic precision is made such that:

$${\sum }_{k = 1}^{k = K} {Δ}^{′} {A}_{ik} < Δ {A}_{i}$$

For example, step 216 may comprise a step 218 of decreasing, for at least one of the weights Aᵢₖ of layer i, a change in arithmetic precision with which said weight Aᵢₖis represented, by switching the arithmetic precision of said weight Aᵢₖfrom a first arithmetic precision to a second, less precise arithmetic precision. Such a change can be made for at least one, in particular all the weights of the layer i, as long as this change does not result in a total modification Δ′Aᵢ of the weights of the layer i that is greater than or equal to the disruption limit value ΔAᵢ. For example, the precision of at least one weight may be switched from an FP32 precision to an FP16 precision, or from an FP16 precision to an FP8 precision, etc.

Alternatively, or in addition, by way of at least one embodiment, step 216 may comprise a step 220 of zeroing at least one of the weights Aᵢₖof layer i. Such a zeroing can be carried out for one or more weights of the layer i, as long as this zeroing does not cause a total modification of the weights of the layer i greater than or equal to ΔAᵢ calculated for said layer.

In the example shown, by way of at least one embodiment, step 212 is carried out before steps 214 and 216. Of course, by way of at least one embodiment, alternatively, step 212 can be carried out after step 216. According to yet another alternative, by way of at least one embodiment, step 212 can be carried out both before steps 214 and 216, and after steps 214 and 216.

The disruption limit value AA; can be identified by a backward error technique applied to the weights of the trained DNN, starting from the error provided at the output of the trained DNN, to determine the limit disruptions of the weights of the DNN.

Indeed, by denoting Y′ and Y the disrupted and undisrupted outputs of the trained DNN including I layers, I>2, it is possible to write:

Y′=fᵢ((Aᵢ+ΔA_{I})f_{I-1}((A_{I-1}+ΔA_{I-1}) . . . (A2+ΔA2)fᵢ((A₁+ΔA₁)(x+Δx))

where
fᵢ is the activation function of the layer i of the DNN,
Aᵢ is the vector of the weights of the layer i of the DNN, and
ΔAᵢ is the disruption limit value such that Y=Y′
   Assuming that the activation functions are differentiable, and taking a first-order approximation, identifying the AA; values involves finding the solution to the following problem:

$${min}_{Δ {A}_{i}} {\sum }_{i = 1}^{I} \frac{{‖ Δ {A}_{i} ‖}^{2}}{{‖ {A}_{i} ‖}^{2}}$$

with the condition that Y-Y′=ΔY=AΔAᵢ where:

$${A}^{T} = [ \begin{matrix}x ⊗ {( {f}_{p}^{′} ( {A}_{p} {y}_{p - 1} ) {A}_{p} … {f}_{1}^{′} ( {A}_{1} x ) )}^{T} \\ ⋮ \\ {y}_{i - 1} ⊗ {( {f}_{p}^{′} ( {A}_{p} {y}_{p - 1} ) {A}_{p} … {f}_{i}^{′} ( {A}_{i} {y}_{i - 1} ) )}^{T} \\ ⋮ \\ {y}_{p - 1} ⊗ {( {f}_{p}^{′} ( {A}_{p} {y}_{p - 1} ) )}^{T} {( {f}_{p}^{′} ( {A}_{p} {y}_{p - 1} ) {A}_{p} … {f}_{1}^{′} ( {A}_{1} x ) {A}_{1} )}^{T}\end{matrix} ]$$

Thus, the ΔAᵢ will correspond to the disruption limit values of the weights of the layer i beyond which the approximate output Y′ of the DNN will be sufficiently different from the output Y so that the inference precision will be impacted.

Alternatively, by way of at least one embodiment, the disruption limit value ΔAᵢ can be identified by a BERR statistical technique.

Thus, by way of at least one embodiment, the method 200 provides a deep neural network trained is adjusted, the inference cost of which is reduced since:
at least one of its weights is set to zero, in step 212 or 220, and is not taken into account during the inference phase; and/or
at least one of its weights is represented with decreased arithmetic precision such that its consideration generates a decreased inference cost.

In the method 200, the quantization of the trained deep neural network is carried out without any impact on the inference precision of said neural network such that the inference precision is preserved. In this case, by way of at least one embodiment, the target inference precision during the quantization phase is the inference precision obtained following the training of the deep neural network.

Of course, by way of at least one embodiment, it is possible to perform the quantization of the trained deep neural network by targeting a specific inference precision less than the one obtained following the training of the neural network.

FIG. 3 is a schematic depiction of another method for quantizing a deep neural network, DNN, according to one or more embodiments of the invention.

The method 300 of FIG. 3 can be used to carry out the quantization of any type of DNN, and in particular of the DNN 100 of FIG. 1, by way of at least one embodiment.

The method 300 of FIG. 3 comprises all steps of the method 200 of FIG. 2, by way of at least one embodiment.

The method 300 further comprises, before step 216, a step 302 of determining an adjustment limit value, denoted δAᵢ, for a target inference precision. In other words, by way of at least one embodiment, in the method 216, the modification of the weights of the trained DNN is not carried out according to the disruption limit value ΔAᵢ but rather depending on the adjustment limit value δAᵢ.

This adjustment limit value δAᵢ is greater than ΔAᵢ so the quantization causes a decrease in the inference precision. In this case, by way of at least one embodiment, the inference precision of the quantized DNN is degraded, but this can make it possible to further reduce the inference cost of the DNN with a target precision that remains acceptable, for the application and the device concerned.

According to one or more embodiments, during step 302, the adjustment limit value can be determined by trial and error, by iterative search, by dichotomy, or any other method. In the example shown, by way of at least one embodiment, step 302 of determining the adjustment limit value δAᵢ comprises one or more iterations of the following operations, until the adjustment limit value δAᵢ is identified at which the measured inference precision corresponds to the target inference precision:
for at least one, in particular each layer, of the neural network, choosing a candidate adjustment value greater than said disruption limit value,
modifying the value of at least one weight of said layer of said candidate adjustment value, and
measuring the inference precision of said neural network modified on a test base. If the measured precision is equal to the target precision, then the candidate adjustment value corresponds to the adjustment limit value δAᵢ for this layer, otherwise a new iteration is carried out with a new candidate adjustment value.

Once the adjustment limit value δAᵢ has been identified for at least one, and in particular each, layer of the DNN, step 216 is carried out by taking into account said value δAᵢ and not the value ΔAᵢ.

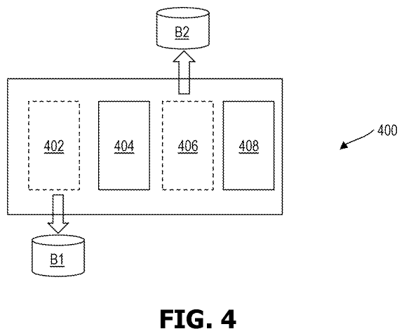

FIG. 4 is a schematic representation of a device according to one or more embodiments of the invention.

The device 400 may be used to implement a method according to one or more embodiments of the invention, and in particular the method 200 of FIG. 2 or the method 300 of FIG. 3.

The device 400 can optionally comprise a module 402 for training a deep neural network for a given application, with a training base B1. The module 402 is for example configured to implement step 202 described above.

The device 400 comprises a module 404 for determining a limit disruption for at least one weight of a neuron, or the weights of at least one layer, for example ΔAᵢ for example by a backward error technique as described above. The module 404 is for example configured to implement step 214 described above.

The device 400 may optionally comprise a module 406 for determining an adjustment limit value for at least one weight of a neuron, or the weights of at least one layer, for example δAᵢ, for example by dichotomy, using a test base B2. The module 406 is for example configured to implement step 302 described above.

The device 400 further comprises at least one module 408 for decreasing an arithmetic precision of at least one weight of the deep neural network, as a function of said adjustment limit value δAᵢ, or said limit disruption ΔAᵢ. The module 408 is for example configured to implement any combination of at least one of the steps 212, 218 and 220 described above, by way of at least one embodiment.

At least one of modules 402-408 may be a module independent of the other modules 402-408. At least two of modules 402-408 may be integrated within a single module, by way of at least one embodiment.

Each module 402-408 may be a hardware module or a software module, such as an application or a computer program, executed by an electronic component of the processor, electronic chip, or computer, etc. type, by way of at least one embodiment.

Of course, the one or more embodiments of the invention are not limited to the examples disclosed above.

1. A method of quantizing a deep neural network, previously trained during a training phase determining for each layer of said deep neural network a set of weights, said method comprising:
a phase of quantizing said deep neural network, said phase comprising:
determining, for at least one layer of said each layer of said deep neural network, a disruption limit value of at least one weight of the set of weights of said at least one layer, beyond which an output of said deep neural network is erroneous,
determining, for a target inference precision and from said disruption limit value, an adjustment limit value of said at least one weight of said set of weights, and
decreasing an arithmetic precision of said at least one weight of said set of weights as a function of said adjustment limit value.

2. The method according to claim 1, wherein the adjustment limit value is equal to the disruption limit value.

3. The method according to claim 2, wherein the adjustment limit value is greater than the disruption limit value, and said determining said adjustment limit value comprises at least one iteration of operations, said operations comprising
for said each layer of the deep neural network, choosing a candidate adjustment value greater than said disruption limit value,
modifying a value of said at least one weight of said each layer of said candidate adjustment value, and
measuring an inference precision of said deep neural network thus modified on a test base;
wherein said operations are reiterated until the candidate adjustment value is identified for which the inference precision that is measured corresponds to the target inference precision.

4. The method according to claim 1, wherein said decreasing said arithmetic precision comprises a zeroing of said at least one weight whose value is less than the adjustment limit value.

5. The method according to claim 1, wherein said decreasing said arithmetic precision comprises changing the arithmetic precision of said at least one weight to a less precise arithmetic precision.

6. The method according to claim 1, wherein for said each layer, the disruption limit value is identified by a backward error technique applied to the set of weights of the deep neural network.

7. The method according to claim 1, wherein for said each layer, the disruption limit value is identified by a BERR statistical technique.

8. The method according to claim 1, wherein the deep neural network is trained for
classification of objects in at least two classes; or
regression of an item of input data in order to provide an item of output data.

9. A non-transitory computer program comprising executable instructions, which, when executed by a computer apparatus, implement a method of quantizing a deep neural network, previously trained during a training phase determining for each layer of said deep neural network a set of weights, said method comprising:
a phase of quantizing said deep neural network, said phase comprising
determining, for at least one layer of said each layer of said deep neural network, a disruption limit value of at least one weight of the set of weights of said at least one layer, beyond which an output of said deep neural network is erroneous,
determining, for a target inference precision and from said disruption limit value, an adjustment limit value of said at least one weight of said set of weights, and
decreasing an arithmetic precision of said at least one weight of said set of weights as a function of said adjustment limit value.

10. A device for quantizing a deep neural network comprising:
one or more of a server, a computer, a tablet and a calculator comprising one or more of hardware and software modules configured to implement a method of quantizing said deep neural network, previously trained during a training phase determining for each layer of said deep neural network a set of weights,
wherein said one or more of said hardware and software modules are configured to
determine, for at least one layer of said each layer of said deep neural network, a disruption limit value of at least one weight of the set of weights of said at least one layer, beyond which an output of said deep neural network is erroneous,
determine, for a target inference precision and from said disruption limit value, an adjustment limit value of said at least one weight of said set of weights, and
decrease an arithmetic precision of said at least one weight of said set of weights as a function of said adjustment limit value.

11. (canceled)
